(19) United States
(12) Patent Application Publication
(10) Pub. No.: US 2004/0001492 A1
(43) Pub. Date: Jan. 1, 2004

(54) Method and system for maintaining a MAC address filtering table

(76) Inventor: Erik J. Johnson, Portland, OR (US)

Correspondence Address: KENYON & KENYON, 1500 K STREET, N.W., SUITE 700, WASHINGTON, DC, 20005, US

(21) Appl. No.: 10/185,064

(22) Filed: Jul. 1, 2002

(51) Int. Cl. H04L 12/28; H04L 12/54

(52) U.S. Cl. 370/395.32; 370/420; 370/392

(57) ABSTRACT

Embodiments of the present invention relate to a method and system for efficiently maintaining a MAC address filtering table. According to the embodiments, a first entry in a linked list of the filtering table may be deleted without delaying or compromising the integrity of a concurrent look-up in the table.

### FIELD OF THE INVENTION

Embodiments of the present invention relate to a method and system for maintaining a MAC (media access control) address filtering table, and more particularly to a method and system for deleting an entry in the MAC address filtering table without delaying or compromising the integrity of a look-up in the filtering table.

### BACKGROUND OF THE INVENTION

A forwarding element is logic in a network device responsible for receiving data frames or packets arriving on one interface, processing them, and typically, forwarding them out another interface to the appropriate recipients. A data frame may be encoded with a destination MAC address uniquely identifying its intended recipient device or devices. This unique destination MAC address enables the forwarding element to recognize and accept frames that it is responsible for forwarding and to discard other frames.

A forwarding element may utilize a MAC address “filtering table” to determine which frames to accept for further processing and routing, and which frames to drop or discard. More specifically, upon receiving a data frame, a forwarding element may perform a “look-up” in a MAC address filtering table for a MAC address corresponding to the MAC address in the received frame. If a corresponding MAC address is found in the table, the received frame may be accepted and processed; if not, the received frame may be dropped or discarded (not processed).

Typically, based on fluctuating network usage, a MAC address filtering table needs to constantly have new addresses added and old addresses deleted. For example, devices communicating via the network may be computers exchanging data packets pursuant to an interactive communication session such as an Internet “webcast,” wherein multiple computer users can view and contribute to a shared information stream. In such a setting, the number of users may grow or shrink unpredictably as users “log in” or “log out” of the session in a random fashion. To accommodate this dynamically changing situation, new destination MAC addresses, corresponding to arriving and departing users, must be constantly generated and then subsequently eliminated by the network. MAC address filtering tables must be correspondingly maintained by adding and deleting the MAC addresses as needed. As MAC address filtering table sizes grow, the importance of efficiently performing look-ups, additions and deletions increases.

In some known implementations, an effort is made to de-couple or partition the look-up operation and the adding and deleting operations into separate “planes.” More specifically, the look-up operation, which occurs with every received packet, may be viewed as taking place in a “data plane.” On the other hand, the adding and deleting operations (also referred to as table “maintenance”) may be viewed as taking place in a “control plane,” among other reasons because they are typically more intermittent than look-up operations. It may be considered desirable to maintain a partitioning between the data and control planes, among other reasons, so that operations in the respective planes do not interfere with each other.

Known implementations may attempt to de-couple the data and control planes by implementing the respective operations of these planes in hardware to the extent possible. For example, known implementations may utilize content-addressable memory (CAM), located in framing and access hardware of the interfaces handled by the forwarding element, for the filtering table. In such a hardware-based solution, table look-ups are not interfered with by table maintenance. However, CAM is expensive and consequently there are practical limitations on its size. Typically, the amount of CAM in the framing and access hardware available to a forwarding element is small or non-existent. Moreover, if the number of MAC addresses that the filtering table needs to hold exceeds the capacity of the CAM, the forwarding element must provide for MAC address filtering and maintenance operations in software. Since a forwarding element cannot a priori know the available CAM capacity and the number of MAC addresses it will need to accommodate, a software solution is an implicit requirement in any production-quality forwarding element.

Known software implementations of MAC address filtering table look-up and maintenance operations may utilize a data structure for the table known as a “linked list.” Maintenance operations on a linked list, however, in particular the operation of deleting an entry, may delay a look-up operation, as described in more detail in the following. In view of the foregoing considerations, embodiments of the present invention provide a method and system for efficiently maintaining a MAC address filtering table without interfering with a table look-up, thereby maintaining the desired separation between the control and data planes.

### BRIEF DESCRIPTION OF THE DRAWINGS

FIG. 1 shows an example of a network wherein embodiments of the present invention could be used;

FIGS. 2A-2C show examples of operations on linked lists;

FIG. 2D shows one possible configuration of a “hash table” for use in packet forwarding;

FIGS. 2E-2G show deleting an entry from a MAC address filtering table according to embodiments of the invention;

FIG. 3 shows a process flow for a look-up in a MAC address filtering table according to embodiments of the invention; and

FIG. 4 shows a process flow for deleting an entry from a MAC address filtering table according to embodiments of the invention.

### DETAILED DESCRIPTION

Embodiments of the present invention relate to a method and system to delete a first entry in a linked “collision” list of a MAC address filtering table without delaying a possibly concurrent look-up process. A collision list results from duplication in values used to index a MAC address filtering table, as described in more detail hereinafter. The method includes atomically “invalidating” the first entry in the linked collision list. As also discussed in more detail below, “invalidating” in this context means marking the first entry to cause a possibly concurrent look-up process to ignore or bypass the first entry for purposes of accepting or dropping an arriving data packet, while still permitting the look-up process to use a next entry pointer of the first entry to access the next entry in the collision list. The first entry may then be replaced by the next entry in the collision list. The replacement entry (now the first entry in the collision list) may then be marked valid, so that the look-up process will consider it for purposes of accepting or dropping an arriving data packet, and a pointer of the replacement entry may be correspondingly adjusted. The individual operations of marking an entry valid or invalid, and of adjusting pointers, may be performed “atomically,” as indicated. The meaning of the term “atomically” in this context will be discussed more fully below, but for the present it is simply noted these that atomic operations may be performed without delaying or compromising the integrity of the look-up process. Thus, according to embodiments of the invention, the desired separation between the control and data planes may be realized.

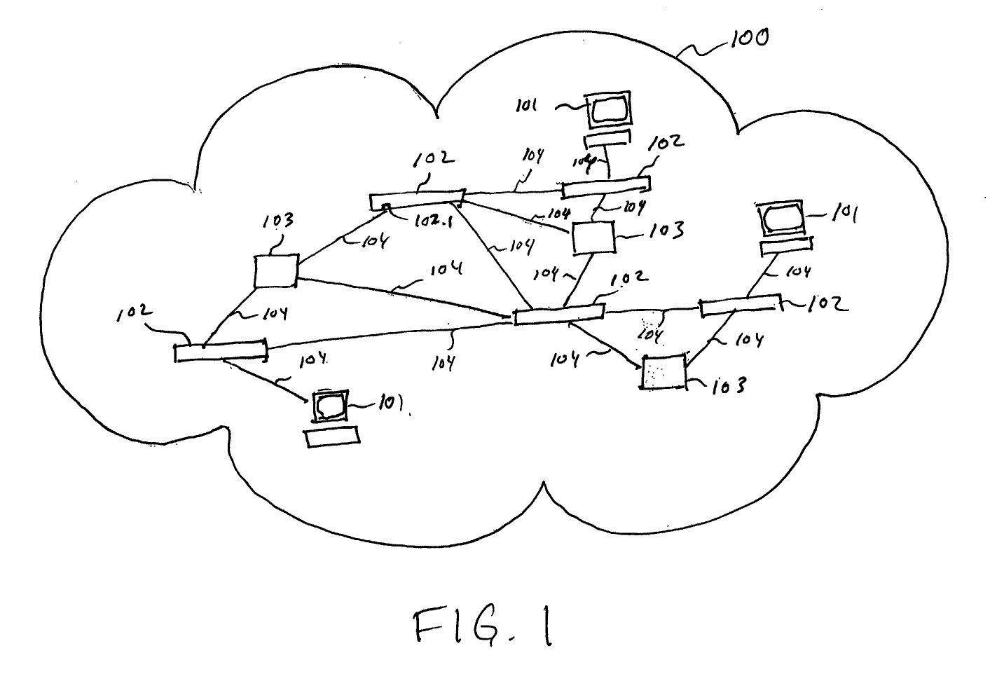

FIG. 1 shows an environment wherein embodiments of the present invention might find advantageous application. FIG. 1 illustrates a network 100 comprising users 101, network devices such as routers 102, servers 103 and connections 104 therebetween. Connections 104 may be implemented via wired or wireless communication media. Requests by a user 101, for example, for information on a server 103 typically generates data packets directed from the user to the server, and data packets from the server to the user in reply to the request. Via connections 104, the packets typically pass through at least one network device comprising a forwarding element that performs MAC address filtering pursuant to forwarding operations, such as a router 102, as the packets are propagated across the network to their respective destinations. A router 102 is responsible for ensuring that arriving packets are sent on to the proper destination.

A network device such as a router 102 may receive an arriving packet at an input port 102.1 coupled to communication medium 104. For each packet that arrives at a router, a forwarding element of the router may make a decision whether to accept or drop the packet, depending on whether a look-up in a MAC address filtering table determines that the packet has a corresponding entry. Further, MAC address entries may need to be added to and deleted from the filtering table based on network usage as described above. Such MAC address filtering table look-ups, additions and deletions may be performed by computer-executable instructions executing on the network device. For example, the instructions may be executed on a “blade” of a router. A blade is typically a thin, modular electronic circuit board that includes one or more microprocessors and memory, input and output ports, and peripheral devices specialized for network applications. A blade can be inserted into a space-saving rack with many similar blades. Because of space limitations, computational efficiency and efficient utilization of memory are naturally at a premium on a blade.

While, for illustrative purposes, routers have been discussed in some detail above as one example of network devices comprising forwarding elements that utilize MAC addresses filtering tables, embodiments of the present invention are not limited to use in routers. Other kinds of network devices that may perform MAC address filtering table look-ups, additions and deletions include, for example, personal computers such as might be used by a user 101, servers such as servers 103, switches, and router variants such as firewalls, network address translators (NATs), and load balancers. Embodiments of the present invention would find useful application in such devices as well.

As touched upon above, linked lists have been used for MAC address filtering applications. In a linked list, each entry contains a pointer to the next entry. When a new entry is added, a pointer to the new entry is created in the last entry. To delete an entry, the pointer to it is eliminated.

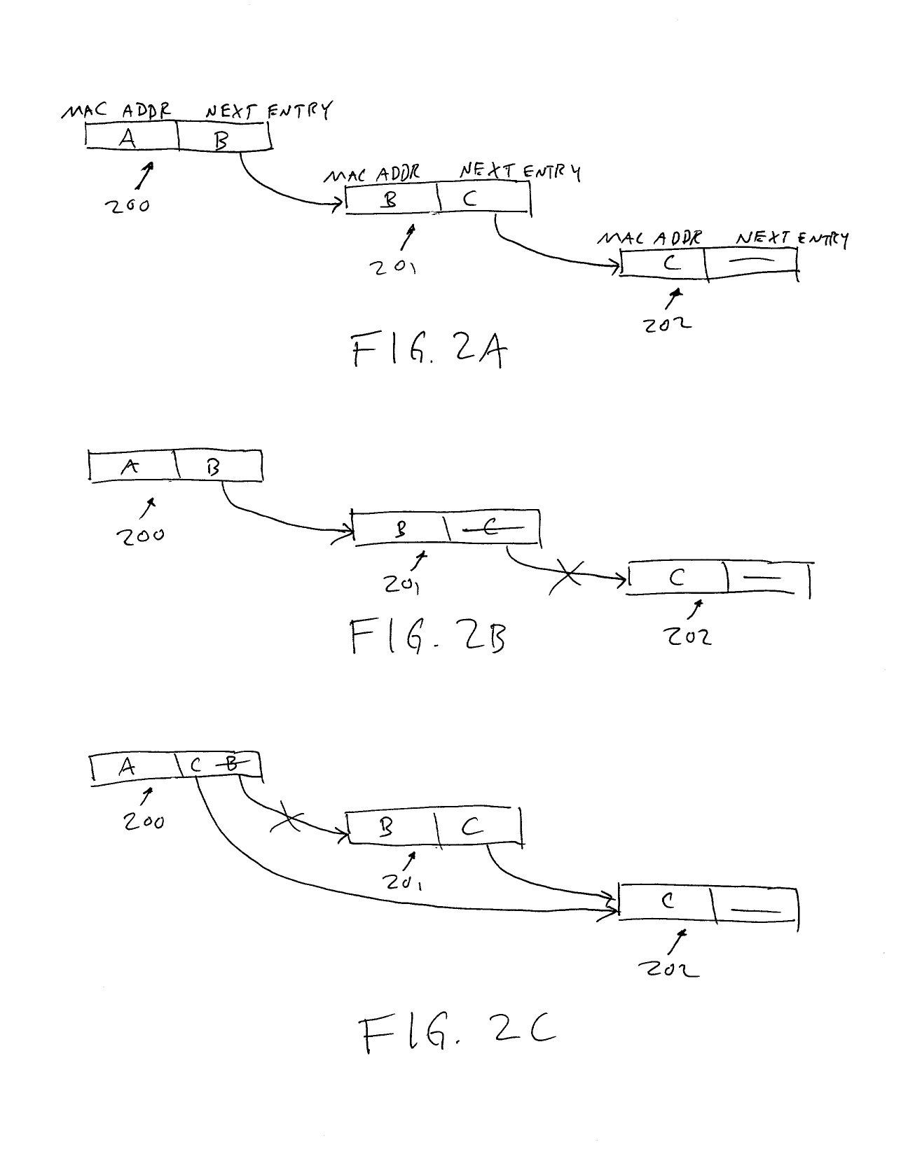

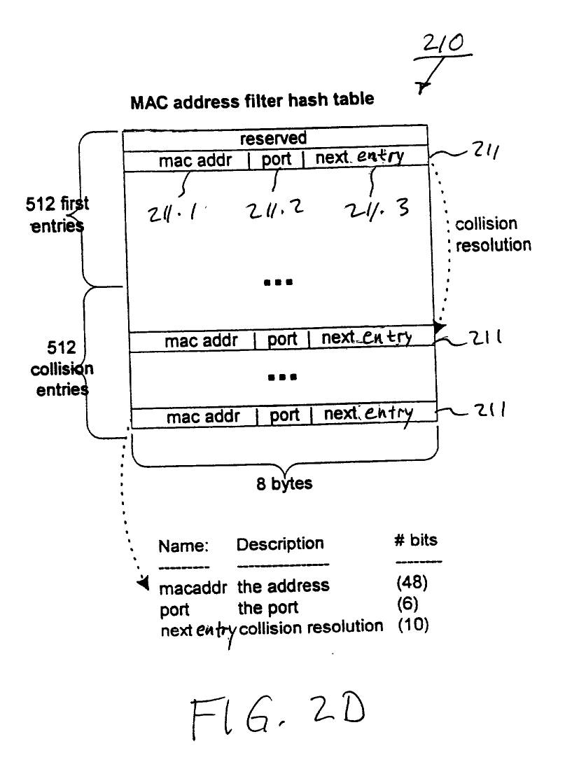

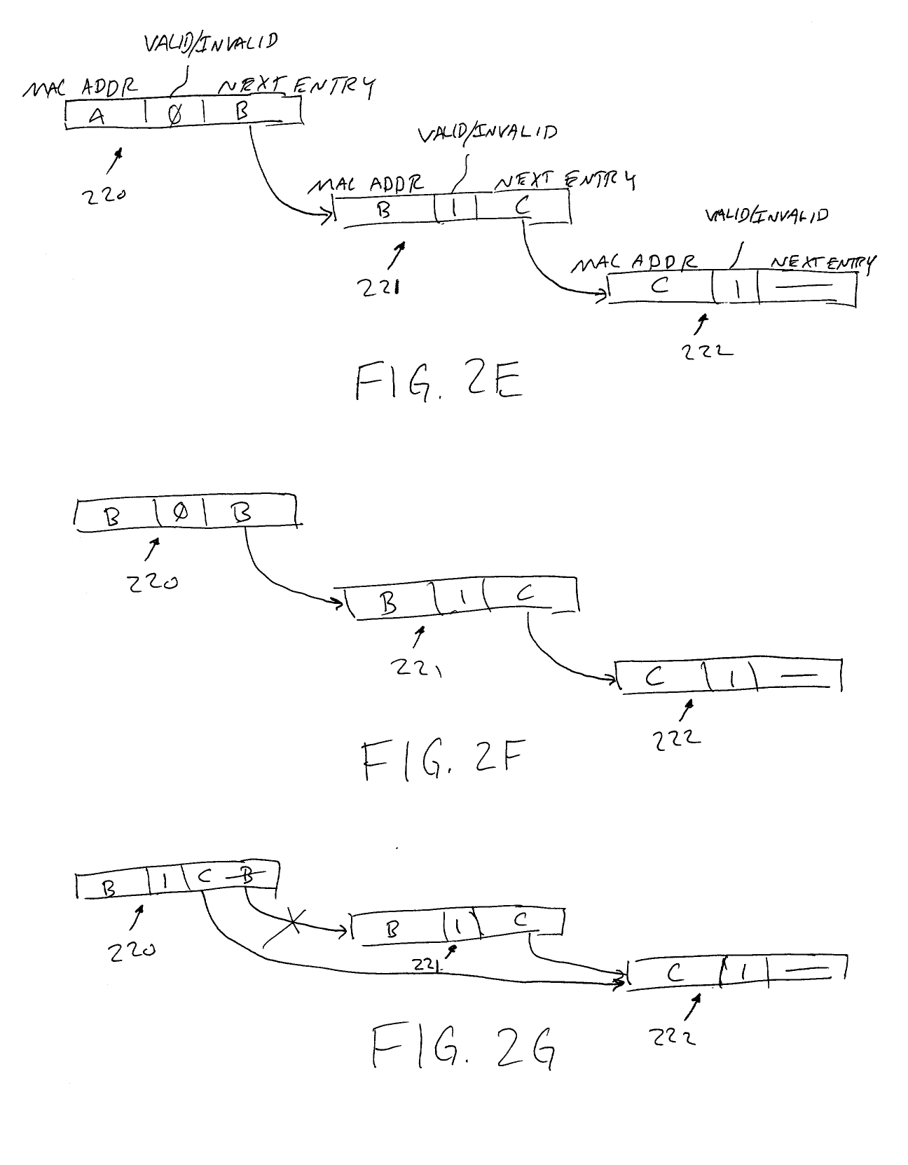

FIGS. 2A-2C illustrate some operations on linked lists. FIG. 2A shows a first linked list entry 200 comprising a MAC address “A” and a pointer to a next entry “B” 201. The “B” entry 201 comprises a MAC address “B” and a pointer to a next entry “C” 202. The “C” entry 202 comprises a MAC address “C” but does not have a next entry; i.e., it is at the end of the list.

FIG. 2B shows deleting the “C” entry 202. To delete the “C” entry 202, the “C” entry 202 is simply “unlinked” by eliminating the pointer to the “C” entry 202 in the “B” entry 201. FIG. 2C shows deleting the “B” entry 201. To delete the “B” entry 201, the pointer to the “B” entry 201 in the “A” entry 200 is replaced by a pointer to the “C” entry 202, effectively “linking around” the “B” entry 201. These deleting operations are easily and efficiently performed in a computer. However, deleting the “A” entry, that is, the first entry in the linked list, is not so straightforward, as described in more detail later.

While it would be possible to use a linked list to implement a MAC address filtering table, traversing long linked lists to find MAC addresses is computationally slow and inefficient. With the high throughput demanded by today's networks, such an implementation would be impracticable. Moreover, it is important to efficiently use the memory available for filtering tables. As described earlier, new MAC addresses corresponding to newly-arriving packets may need to be stored in the available memory for an indeterminate period of time. During peak traffic periods, the volume of new packets can even exceed the available memory capacity, requiring that some packets be dropped even though they have valid MAC addresses. Additionally, MAC addresses may be of a substantial length: for example, a typical MAC address is 48 bits long. These 48 bits allow for 2⁴⁸ possible distinct MAC addresses. To directly store and index all such possible MAC addresses would obviously entail prohibitive memory requirements.

Accordingly, one approach which is used in the art to reduce memory requirements in packet forwarding applications to more manageable levels is to form a data structure known as a “hash table” for use in filtering. In this context, a “hashing” operation, generally, reduces a given number of bits to a smaller number of bits, while retaining, to the extent possible, an identity or one-to-one-one correspondence between the original group of bits and the reduced group. Thus, for example, a hashing operation could reduce an incoming 48-bit MAC address to a 10-bit value. A collection of MAC addresses could then be stored in a hash table that could be directly indexed by the respective hashed values of the MAC addresses. The hash table could be much smaller than one required to directly index the range of possible full MAC addresses: i.e., sized for 2¹⁰ entries as opposed to 2⁴⁸. So long as the hashed addresses mapped uniquely to their corresponding full addresses, the hash table could be used to efficiently store MAC addresses accessible by a forwarding element, and enable the necessary filtering operations to be performed.

However, MAC addresses do not in every case hash to unique values. The reduction of bits associated with hashing entails the loss of a certain amount of information. Thus, from time to time, two or more different full MAC addresses will hash to the same value. In networks, this occurrence is known as “collision,” and is typically handled by processing referred to as “collision resolution.” In collision resolution, if two or more different MAC addresses hash to the same value, a linked list is formed from the colliding MAC addresses; that is, the entries corresponding to the MAC addresses are linked to each other in the hash table. Typically, the number of collisions will be small and so there will not be a great number of these linked entries (on the order of two or three, typically). Subsequently, if another incoming MAC address hashes to a value that indexes (points to) one of the linked entries, the linked entries are traversed to determine which, if any, of the entries has a MAC address matching the incoming address.

For example, suppose each of two different full MAC addresses “A” and “B” hashes to the identical reduced value “X”. Further, suppose that entries were formed for these colliding entries in the hash table such that “X” points to the entry for address “A”, and that the entry for address “A” points to (is linked to) the entry for address “B”. Then, suppose a packet with MAC address “B” is received. In this event, because address “B” hashes to “X”, a look-up will find the entry for address “A”. However, because “A” does not match the incoming MAC address, the entry pointed to by the entry for address “A” (that is, the entry for address “B”) will then be read to determine it matches the incoming address. In this example, there is a match, so the incoming packet is accepted. On the other hand, an incoming packet may have yet a third MAC address “C” that also hashes to value “X”, but address “C” may have no corresponding entry in the filtering table. In this event, a look-up for address “C” would find the entry for address “A” (no match) which would point to the entry for address “B” (again, no match), and accordingly the incoming packet would be dropped. (It should be understood that the logic that decides whether to add an entry to the filtering table, and the look-up logic described herein which decides whether to accept or drop a packet based on the contents of the filtering table, are independent of each other; i.e., they are in separate control and data planes, respectively.)

FIG. 2D shows an example of one possible format of a hash table 210 for MAC address filtering. The hash table 210 may contain a plurality of entries, such as entries 211. Each entry may comprise a field 211.1 for storing the MAC address, a field 211.2 for identifying a port associated with the MAC address, and a “next entry” field 211.3, which could point to another entry in a collision list. The table could be sized to hold 1024 entries, corresponding to 2¹⁰ possible distinct hash values. Arbitrarily, the first 512 table locations could be set aside for “normal,” i.e., “uncollided” entries, while the second 512 locations could be set aside for collision entries. As noted above, usually the number of entries in collision lists will be small and not entail substantial searching overhead.

A problem that arises in connection with collision lists, however, involves the deletion of entries, and the effect the deletion of an entry may have on a table look-up that may be occurring at the same time. Typically, one reason that entries in a MAC filtering table may be deleted is based on an “aging” process; that is, if an entry has not been accessed for a pre-determined period of time, the entry may be deleted in order to free up space in the table. Deleting entries in a linked collision list when the entries are at the end of the list or somewhere in the middle of the list is straightforward, as outlined above in the discussion of FIGS. 2A-2C. If the entry is at the end of the list, deleting the entry involves only eliminating the pointer to the entry in the preceding entry (see FIG. 2B). If the entry is somewhere in the middle of the list, deleting the entry involves only changing the pointer in the preceding entry to point to the following entry (see FIG. 2C). These operations of changing a pointer may be performed “atomically,” and consequently do not affect a concurrent look-up. An “atomic” operation as referred to herein essentially means that the operation is indivisible or irreducible, such that no intervening operation affecting a result of the atomic operation can occur. For example, it could mean that the operation can be performed in the smallest division of a computer cycle for a given computer configuration. If the entry to be deleted is the first in the list, however, it typically cannot be deleted without potentially invalidating a concurrent look-up, and therefore the look-up process may be delayed to allow the entry to be deleted.

More specifically, in known methods for deleting the first entry in a linked collision list in a hash table, the deletion requires copying the entry pointed to by the first entry into the position occupied by the first entry. The copying operation cannot be performed atomically. Therefore, to ensure that a possibly concurrent look-up process does not attempt to read the data being copied into the first entry position before the copy is complete, it is necessary to temporarily delay the look-up process while the delete is performed. If the look-up process were not delayed, it could read incomplete or invalid data from the first entry position.

Embodiments of the present invention, by contrast, enable the deletion of the first entry in a linked collision list in a hash table without delaying a concurrent look-up. According to the embodiments, deleting the first entry may comprise atomically “invalidating” the first entry. “Invalidating” in this context means marking the entry to indicate to the look-up process that the entry should not be considered for purposes of accepting or dropping a packet. Such an invalidated entry will therefore simply be ignored by the look-up process, but the entry's pointer to the rest of the collision list will remain valid for purposes of the look-up process, allowing the pointer to be used to find and access a next entry of the list. Moreover, because the invalidating operation is atomic, it does not delay or otherwise affect the look-up process.

Subsequently, the entry pointed to by the first entry may be copied into the first entry position. The first entry, at this point, will continue to be marked as invalid. Following the copy operation, therefore, there will be two versions of the entry pointed to by the first entry: one version in its original location, and the copied version now in the first entry position. The copied version is still marked invalid, as noted previously, so that it will be ignored by the look-up process. However, the next entry pointer of the copied version may still be utilized by the look-up process to find the version in its original location. The copied version may then be marked as valid, so that subsequent look-ups will not ignore the copied version but will instead consider it for purposes of accepting or dropping a packet.

Then, because the version in its original location is not the first entry in the linked list, it may be deleted atomically without delaying a look-up operation. More specifically, the copied version that is now the first entry in the linked list may now be unlinked from the version in its original location and re-linked to a different next entry, or simply unlinked. The copied version has thus essentially replaced the original first entry. The foregoing marking valid, unlinking, and re-linking operations may each, individually, be performed 1atomically so that they do not delay a look-up operation. The deletion operation has therefore been performed without in any way delaying a concurrent look-up operation.

FIGS. 2E-2G illustrate the foregoing. FIG. 2E shows a first linked list entry 220 comprising a MAC address “A”, a valid/invalid field, and a pointer to a next entry “B” 221. The “B” entry 221 comprises a MAC address “B”, a valid/invalid field, and a pointer to a next entry “C” 232. The “C” entry 222 comprises a MAC address “C”, a valid/invalid field, but does not have a next entry; i.e., it is at the end of the list.

Let “0” in the valid/invalid field indicate an invalidated entry, and let “1” in the valid/invalid field indicate a valid entry. FIG. 2E shows entry “A” 220 having been marked invalid as part of deleting entry “A” according to embodiments of the invention. The pointer to entry “B” 221, however, is still valid and may be used by a look-up process to find and access entry “B”.

FIG. 2F shows entry “B” 221 having been copied into the position formerly occupied by entry “A” 220. Entry 220 is still marked invalid, but a valid version of entry “B” remains, i.e., entry 221, which may be found through the next entry pointer of entry 220. Then, as shown in FIG. 2G, entry 220 is marked valid, unlinked from entry 221, and linked to entry 222, each an operation which may be performed atomically. Because entry 220 is now marked valid, the look-up process will subsequently consider entry 220 for purposes of accepting or dropping a packet. If, for example, there had been no entry 222 (i.e., only an entry 220 and an entry 221), entry 220 would simply have been marked valid and unlinked from entry 221.

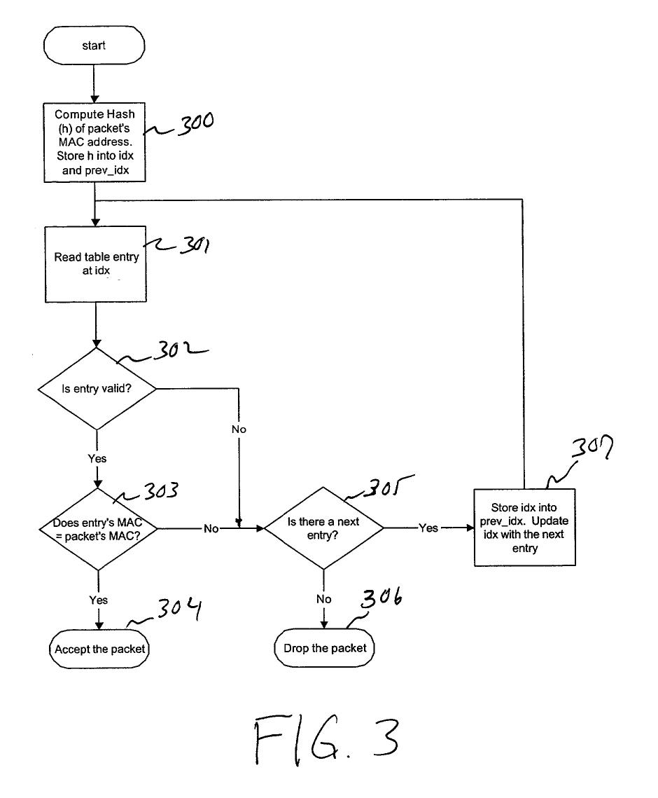

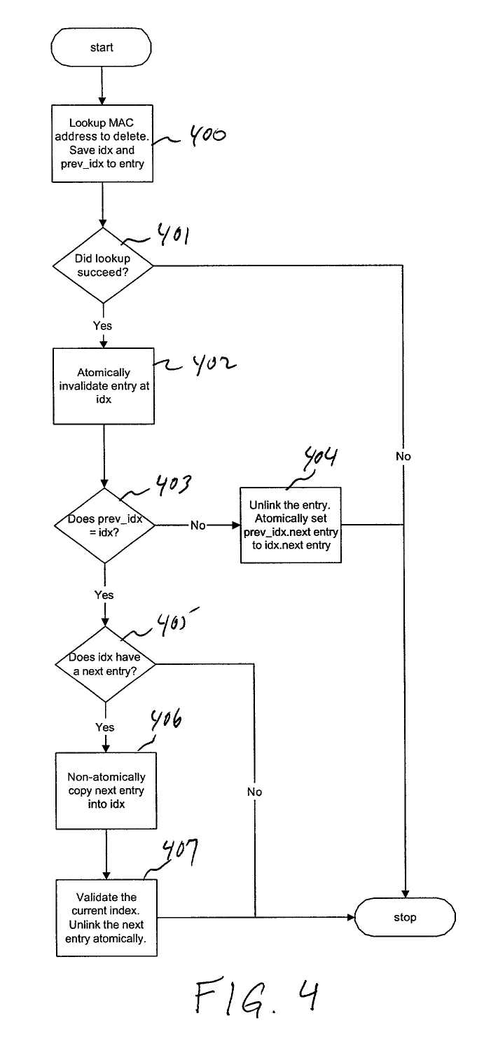

FIGS. 3 and 4 are flowcharts illustrating a sequence of operations for effecting processes according to embodiments of the present invention. FIG. 3 shows a hash table look-up process. As shown in block 300, a hash value (h) may be computed from a received packet's MAC address. Various hashing functions for accomplishing this are well known. The computed hash value may then be stored into a pointer or index, denoted arbitrarily in FIG. 3 as “idx”, for indexing the hash table. The “idx” pointer points to a current entry, that is, an entry currently being looked up. The computed hash value may also be stored into a variable denoted here as “prev_idx”, which may be used in subsequent operations to point to the entry previously looked up. Then, as shown in block 301, the entry in the hash table pointed to by the current index, “idx”, may be read.

It may then be determined whether the entry pointed to by the current index is a valid entry, as shown in block 302. Block 302 represents in at least one respect a departure from known methods. As discussed earlier, according to embodiments of the invention, during a delete a table entry may be atomically marked as invalid so that the look-up process will bypass or ignore the entry. Block 302 represents a check by the look-up process to see if this has been done. Including this check in the look-up process lets the look-up process go forward even though a delete might be occurring at the same time. That is, the check informs the look-up process that the entry may be in the process of being deleted, but that its pointer to a next entry, if any, is still valid and may be used by the look-up process to find the next entry. By contrast, in prior art methods, the look-up process would need to be delayed while the delete was performed.

If the result of the determination of block 302 is that the entry pointed to by the current index is valid, it may then be determined whether the MAC address for the entry currently indexed by the hash value is the same as the received packet's MAC address, as shown in block 303. If so, the packet may be accepted as shown in block 304.

On the other hand, if the result of the determination of block 302 is that the entry pointed to by the current index is invalid, or if the result of the determination of block 303 is that the MAC address for the entry currently indexed by the hash value is not the same as the received packet's MAC address (indicating that a collision has occurred), block 305 may be executed. In block 305, it may be determined whether a “next entry” pointer (corresponding, for example, to the “next entry” field 211.3 shown in FIG. 2D) exists for the currently-indexed entry. This next entry pointer, as illustrated in FIGS. 2A-2G, is one way a linked collision list as described above may be formed. More specifically, if there is a next entry, this is an indication at least two entries have been linked; i.e., that a collision list of at least two entries has been formed. On the other hand, if there is no next entry, this is an indication that either no collision list has been formed or that all of a collision list has been traversed. Thus, if the result of the determination of block 305 is that the currently-indexed entry does not point to any next entry, no entry exists in the filtering table corresponding to the received packet. Accordingly, the packet is dropped, as shown in block 306.

On the other hand, if the result of the determination of block 305 is that the currently-indexed entry does point to a next entry, this is an indication that at least one more entry in a collision list remains to be traversed. Therefore, as shown in block 307, the current index is stored into the “prev_idx” value and then updated with the pointer to the next entry, and the flows returns to block 301.

FIG. 4 shows a process flow for deleting entries in a MAC address filtering table generally, and more specifically, includes operations for deleting entries from a collision list according to embodiments of the invention. As shown in block 400, a look-up (that is, a look-up as described with reference to FIG. 3, except that the look-up does not result in accepting or dropping a packet, but instead only attempts to locate a table entry to delete it) may be performed of a MAC address to be deleted, for example, as a result of an aging process as described above. The values that the “idx” and “prev_idx” variables have when the look-up is exited from may be saved.

As shown in block 401, it may next be determined whether the look-up succeeded: that is, whether the look-up found the MAC address to be deleted in the hash filtering table. If not, there is no need to delete the address and the process simply stops.

On the other hand, if the look-up finds the MAC address, the process may continue to block 402. Block 402 illustrates atomically invalidating the entry to be deleted. This invalidating operation could be accomplished in different ways. For example, referring to FIG. 2D, an invalid port address could be written into the port field 211.2. Alternatively, according to a different hash table configuration, an entry could simply be provided with a “valid/invalid” field (as shown, for example, in FIGS. 2E-2F) such as a bit that could be toggled atomically. Functionally, the result would be the same in that the look-up process would bypass or ignore the invalidated entry for purposes of accepting a packet, while still checking for whether the invalidated entry has a next entry pointer.

Next, block 403 could be executed. Block 403 represents testing for one of multiple possibilities: (1) (the “no” branch) the entry just looked up is part of a collision list, and the entry is not the first entry in the collision list; or (2) (the “yes” branch) either the entry just looked up is not part of a collision list, or the entry is the first entry in a collision list. More specifically, “prev_idx” will only be equal to “idx” if the entry just looked up is not part of a collision list, or is the first entry in a collision list, as can be seen by reviewing the look-up process illustrated in FIG. 3. Therefore, if the result of the determination of block 403 causes the “no” branch to be taken, the entry may be deleted atomically as shown in block 404. That is, a pointer (“prev_idx.next_entry”) in the entry that points to the entry being deleted may be set to point to the entry pointed to by the entry being deleted (“idx_next_entry”). This operation in effect “skips over” or “links around” the entry being deleted if the entry being deleted is somewhere in the middle of the collision list, and “unlinks” the entry if it is at the end of the list. Examples of such operations are shown in FIGS. 2A-2C and 2E-2G, described above.

On the other hand, if the result of the determination of block 403 causes the “yes” branch to be taken, it may be determined whether the entry is part of a linked collision list, as shown in block 405. In block 405, it is determined whether the current entry points to a next entry, which as discussed above, is an indication that the current entry is part of a linked collision list. If the result of the determination of block 405 is that the current entry is not part of a linked collision list (the “no” branch), the delete process may stop, since the current entry has been invalidated, and therefore for purposes of a look-up no longer exists.

On the other hand, the logical condition that leads to both the tests in blocks 403 and 405 taking the “yes” branch is that the entry currently being deleted is the first entry in a linked collision list. It may be recalled that this is a problematic condition for the prior art which is addressed by embodiments of the present invention. More specifically, while prior art methods would need to delay a possibly concurrent look-up process while block 406 was executed, such delay is avoided according to embodiments of the present invention. In block 406, the next entry in the linked collision list, pointed to by the first entry, is non-atomically copied into the position formerly occupied by the first entry. Typically, this would require a possibly concurrent look-up to be delayed, to avoid the possibility of the look-up reading partial or invalid data from the position being copied into. However, because according to embodiments of the invention, the entry being deleted is invalidated in block 402, the look-up process bypasses the position being copied into, but still utilizes the first entry's next entry pointer to access the next entry if needed.

Following the copy operation of block 406, there are two versions of the entry pointed to by the first entry. One version is in its original position, and the other, copied version, is in the position formerly occupied by the first entry. As shown in block 407, the copied version may then be validated so that a look-up will consider it for purposes of accepting a packet. Since the version in its original position is not the first entry in the linked collision, it can unlinked (deleted) atomically as further shown in block 407. The atomic operations shown in block 407 may be performed without any delay of a concurrent look-up. Thus, the entire process of deleting the first entry of a linked collision list may be performed without any delay to a concurrent look-up process.

To promote understanding, some illustrative examples will now be discussed in connection with the look-up and delete processes shown in FIGS. 3 and 4, respectively. Suppose, for example, a delete of an entry corresponding to a MAC address “A” is to be performed, but that no entry exists in the MAC address filtering table for MAC address “A”. The result of the determination of block 401 would cause the “no” branch to be taken, and the process would stop.

Next, suppose a delete of an entry corresponding to a MAC address “A” is to be performed, that an entry exists in the MAC address filtering table for MAC address “A”, and that it is not part of a collision list. Under these conditions, the “yes” branch of block 401 would be taken, and block 402 would be executed to invalidate the entry for address “A”. Then, the “yes” branch of block 403 would be taken because “idx” would be equal to “prev_idx” for entry “A”. But, because the entry for “A” is not linked to any other entries, the “no” branch of block 405 would be taken, and the process would stop.

Now, suppose a delete of an entry corresponding to a MAC address “B” is to be performed, that an entry exists in the MAC address filtering table for MAC address “B”, but that the entry for “B” is part of a linked collision list. More specifically, suppose the “B” entry is the second entry in the collision list, and is pointed to by an “A” entry which is the first in the collision list. Under these conditions, a look-up of the “B” entry would succeed (“yes” branch of block 401) and the “B” entry would be atomically invalidated. Then, the “no” branch of block 403 would be taken because the “idx” and “prev_idx” pointers would be different coming out of the look-up routine. Accordingly, the “B” entry could be atomically unlinked as shown in block 404, and the process would end.

Finally, suppose a delete of an entry corresponding to a MAC address “A” is to be performed, and that the entry for “A” is the first entry in a two-entry collision list wherein the “A” entry points to a “B” entry. Under these conditions, a look-up of the “A” entry would succeed (“yes” branch of block 401) and the “A” entry would be atomically invalidated. Then, the “yes” branch of block 403 would be taken because the “idx” and “prev_idx” pointers would be the same coming out of the look-up routine. Accordingly, the “B” entry would be copied into the position formerly occupied by the “A” entry (block 406), the copied “B” entry would be validated, and then the original “B” entry would be unlinked, each operations which may be performed atomically (block 407). These operations correspond to those illustrated in FIGS. 2E-2G.

As described earlier, embodiments of the invention may be implemented in computer-executable instructions that execute on a network device. To that end, the device may comprise one or more microprocessors and memory, input and output ports, and peripheral devices. The computer-executable instructions may be stored and transported on computer-usable media such as diskettes, CD-ROMs, magnetic tape or hard disk. The instructions may be retrieved from the media and executed by a processor to effect a method according to embodiments of the invention.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method to delete a first entry in a linked collision list of a MAC address filtering table, comprising:
invalidating said first entry; and
unlinking said first entry from a next entry pointed to by said first entry.

2. The method of claim 1, further comprising:
replacing said first entry with said next entry; and
validating said replaced first entry.

3. The method of claim 1, wherein said invalidating causes a concurrent look-up process to ignore said first entry for purposes of accepting or dropping an arriving data packet, but permits said look-up process to use a next entry pointer of said first entry to access said next entry.

4. The method of claim 2, further comprising linking said replaced first entry to another entry of said collision list.

5. A method comprising:
forming a linked collision list in a MAC address filtering table; and
deleting a first entry of said linked collision list by marking said first entry invalid, said marking invalid leaving a pointer of said first entry to a next entry of said collision list unchanged.

6. The method of claim 5, wherein said marking invalid causes a look-up in said MAC address filtering table to ignore said first entry for purposes of accepting or dropping an arriving data packet, while allowing said look-up to utilize said pointer to access said next entry.

7. The method of claim 5, further comprising copying said next entry into a position occupied by said first entry.

8. The method of claim 7, further comprising marking said copied next entry valid.

9. The method of claim 8, wherein said marking valid causes a look-up in said MAC address filtering table to consider said copied next entry for purposes of accepting or dropping an arriving data packet.

10. The method of claim 8, further comprising unlinking said copied next entry from said next entry.

11. The method of claim 10, further comprising linking said copied next entry to another entry in said collision list.

12. A network device comprising:
an input port couplable to a communication medium; and
computer-executable instructions configured to delete a first entry in a linked collision list in a MAC address filtering table corresponding to data packets received via said communication medium, said instructions when executed performing a method comprising marking said first entry invalid, said marking invalid leaving a pointer of said first entry to a next entry of said collision list unchanged.

13. The network device of claim 12, wherein said marking invalid causes a look-up in said MAC address filtering table to ignore said first entry for purposes of accepting or dropping an arriving data packet, while allowing said look-up to utilize said pointer to access said next entry.

14. The network device of claim 12, said method further comprising copying said next entry into a position occupied by said first entry.

15. The network device of claim 14, said method further comprising marking said copied next entry valid.

16. The network device of claim 15, wherein said marking valid causes a look-up in said MAC address filtering table to consider said copied next entry for purposes of accepting or dropping an arriving data packet.

17. The network device of claim 15, said method further comprising unlinking said copied next entry from said next entry.

18. The network device of claim 17, said method further comprising linking said copied next entry to another entry in said collision list.

19. A method for performing a look-up in a MAC address filtering table, comprising:
receiving a data packet containing a MAC address;
accessing an entry in a MAC address filtering table corresponding to said MAC address;
determining whether said entry is valid for purposes of deciding whether to accept or drop said data packet; and
if not, ignoring said entry.

20. The method of claim 19, further comprising using a pointer of said entry to access a next entry.

21. A computer-usable medium comprising computer-executable instructions, said instructions when executed implementing a process to delete a first entry in a linked collision list of a MAC address filtering table, comprising:
invalidating said first entry; and
unlinking said first entry from a next entry pointed to by said first entry.

22. The computer-usable medium of claim 21, further comprising:
replacing said first entry with said next entry; and
validating said replaced first entry.

23. An atomic maintenance method for linked list data structures, comprising:
when a first entry of the linked list is to be deleted, storing a field in a data portion of the first entry to indicate that the data portion is invalid, the storing leaving a pointer portion of the first entry unchanged,
when any other entry of the linked list is to be deleted, amending a pointer portion of an immediately prior entry of the linked list to point to an immediately subsequent entry, if any, of the linked list.

24. The method of claim 23, further comprising:
replacing the data portion of the first entry with the data portion of a next entry pointed to by the pointer portion of the first entry; and
amending the field to indicate that the data portion is valid.

25. A method comprising:
the maintenance method of claim 24; and
a search method, responsive to newly received data, comprising:
for a first entry of the linked list:
determining whether the field indicates the data portion is invalid, and
if so, then advancing the search to a next entry in the linked list; and
iteratively comparing the newly received data against data values stored in each remaining entry of the linked list until a match is discovered.

26. The search method of claim 25, further comprising:
if a match is discovered, accepting the newly received data; and
if not, discarding the newly received data.

27. A search method for a linked list data structure comprising, responsive to a newly received data value:
for a first entry of the linked list:
determining whether a state field of the entry indicates that the entry stores valid data,
comparing a data field of the first entry to the newly received data unless the state field indicates the entry is invalid, and
thereafter, iteratively:
identifying a next entry from a pointer field of a current entry, and
comparing a value stored in a data field of the next entry to the newly received data value.

28. The search method of claim 27, further comprising one of accepting and discarding the newly received data value depending on a result of the comparing.
